(19) United States
(12) Patent Application Publication
(10) Pub. No.: US 2011/0227864 A1
(43) Pub. Date: Sep. 22, 2011

(54) APPARATUS FOR DRIVING TOUCH PANEL

(76) Inventor: Young Jin Baek, Seoul (KR)

(21) Appl. No.: 13/045,773

(22) Filed: Mar. 11, 2011

(30) Foreign Application Priority Data
Mar. 19, 2010 (KR) 10-2010-0024833

(51) Int. Cl. G06F 3/045

(52) U.S. Cl. 345/174

(57) ABSTRACT

Disclosed herein is an apparatus for driving a touch panel, which calibrates a drift of an output voltage, generated by a change of an external environment or touch panel, thereby having excellent noise characteristics, high touch sensitivity. The apparatus includes a touch panel having a plurality of pixels. Each of the pixels is connected to a first capacitor in which their electric charges are stored. A differential amplifier receives and amplifies the amount of electric charges generated by a change in the capacitance of the first capacitor of the touch panel, inputted through two input terminals and outputs the amplified voltage to two output terminals. An analog to digital converter (ADC) receives an output of the differential amplifier as an input and converts the output into a digital value. A reference voltage calibrator outputs positive and negative voltages to the differential amplifier and calibrates a reference voltage. An error calibrator outputs positive and negative voltages to the differential amplifier and calibrates two outputs of the differential amplifier within a voltage input range of the ADC. A controller feeds back the two outputs of the differential amplifier, which are beyond the voltage input range of the ADC, to the error calibrator.

### CROSS-REFERENCE TO RELATED APPLICATION

This application claims priority from and the benefit of Korean Patent Application No. 10-2010-0024833, filed on Mar. 19, 2010, which is hereby incorporated by reference for all purposes as if fully set forth herein.

### BACKGROUND

1. Field of the Invention

Disclosed herein is an apparatus for driving a touch panel. More particularly, disclosed herein is an apparatus for driving a touch panel, which includes a differential amplifier for amplifying a voltage generated by a change in capacitance due to a touch and a calibrator for calibrating a drift of an output voltage, caused by an external environment.

2. Description of the Related Art

FIG. 1 illustrates an apparatus for driving a touch panel according to a related art.

Referring to FIG. 1, in the related art apparatus, a finger comes in contact with a touch panel 10, so that a single output amplifier 20 receives a voltage generated by a change in the capacitance of a capacitor Cₘ connected to a pixel contacted by the finger as an input and amplifies the inputted voltage.

At this time, output voltage Vₒ may be represented by Equation 1 as follows.

$${V}_{o} = \frac{{C}_{m}}{{C}_{f}} {V}_{pul} \qquad ( 1 )$$

Vₚᵤₗ denotes a pulse voltage inputted each pixel on each Y channel Since

$${V}_{o} {DV}_{pul} , {C}_{f} E \frac{{C}_{m}}{{V}_{pul}} .$$

For example, if Cₘ is set as C and C_{f} is set as 2C in the state that no touch is generated, the Vₒ becomes 0.5Vₚᵤₗ.

In the state that a touch is generated, the Cᵤ, of the touch panel is changed into 0.75C, and the C_{f} is maintained as 2C. Therefore, the Vₒ becomes 0.375Vₚᵤₗ.

That is, if a touch is generated in the state that no touch is generated, the changed value of the Vₒ becomes 0.125Vₚᵤₗ.

Hereinafter, a case where a change is generated in the touch panel due to an external environment will be considered.

If the Cₘ of the touch panel is changed into 2C in the state that no touch is generated, the C_{f} is maintained as 2C, and therefore, the Vₒ becomes Vₚᵤₗ.

As a result, since the Vₒ is beyond the input range of an analog to digital converter (ADC), saturation may occur.

If a touch is generated in the state that the Cₘ of the touch panel is changed into 2C, the Cₘ is changed into 1.75C, and the C_{f} is maintained as 2C. Therefore, the Vₒ becomes 0.875Vₚᵤₗ. As a result, since the Vₒ is beyond the input range of the ADC, saturation may occur.

Accordingly, in the related art apparatus, the C_{f} is necessarily is increased considering the change of the touch panel and distributions of elements in processes, and the sensitivity of an output is unavoidably lowered due to the increased capacitance of the C_{f}.

### SUMMARY OF THE INVENTION

Disclosed herein is an apparatus for driving a touch panel having high amplification efficiency, i.e., having excellent noise characteristics and high touch sensitivity, even when the change in the capacitance of Cₘ is small.

Further disclosed herein is an apparatus for driving a touch panel, in which a drift of the output voltage is generated due to a change of the external environment or touch panel, the output voltage is calibrated within the input range of an analog to digital converter, thereby preventing the saturation of the output voltage.

In one embodiment, there is provided an apparatus for driving a touch panel, the apparatus including a touch panel having a plurality of pixels, wherein each of the pixels is connected to a first capacitor in which their electric charges are stored; a differential amplifier for receiving and amplifying the amount of electric charges generated by a change in the capacitance of the first capacitor of the touch panel, inputted through two input terminals and outputting the amplified voltage to two output terminals; an analog to digital converter (ADC) for receiving an output of the differential amplifier as an input and converting the output into a digital value; a reference voltage calibrator for outputting positive and negative voltages to the differential amplifier and calibrating a reference voltage; an error calibrator for outputting positive and negative voltages to the differential amplifier and calibrating two outputs of the differential amplifier within a voltage input range of the ADC; and a controller for feeding back the two outputs of the differential amplifier, which are beyond the voltage input range of the ADC, to the error calibrator.

Capacitors may be respectively provided on circuit paths along which the voltage generated by the change in the capacitance of the first capacitor is inputted to the two input terminals of the differential amplifier.

Capacitors may be respectively provided on circuit paths along which the positive and negative voltages of the reference voltage calibrator are inputted to the differential amplifier.

The two outputs may be calibrated using a value obtained by multiplying the difference between the positive and negative voltages of the reference voltage calibrator by a capacitance ratio of capacitors connected to the reference voltage calibrator.

Capacitors may be respectively provided on circuit paths along which the positive and negative voltages of the error calibrator are inputted to the differential amplifier.

The two outputs may be calibrated using a value obtained by multiplying the difference between the positive and negative voltages of the error calibrator by a capacitance ratio of capacitors connected to the reference voltage calibrator.

The controller may control the output of the differential amplifier every frame.

### BRIEF DESCRIPTION OF THE DRAWINGS

The above and other aspects, features and advantages of the present invention will become apparent from the following description of preferred embodiments given in conjunction with the accompanying drawings, in which:

FIG. 1 illustrates an apparatus for driving a touch panel according to a related art;

FIG. 2 illustrates the configuration of an apparatus for driving a touch panel according to an embodiment;

FIG. 3 illustrates the structure of a differential amplifier according to the embodiment;

FIGS. 4 and 5 illustrate the calibration effect by a reference voltage calibrator and an error calibrator according to the embodiment; and

FIG. 6A illustrates a timing diagram of signals for controlling an apparatus for driving a touch panel according to the embodiment, and FIG. 6B illustrate components of the differential amplifier controlled by the signals illustrated in the timing diagram of FIG. 6A.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

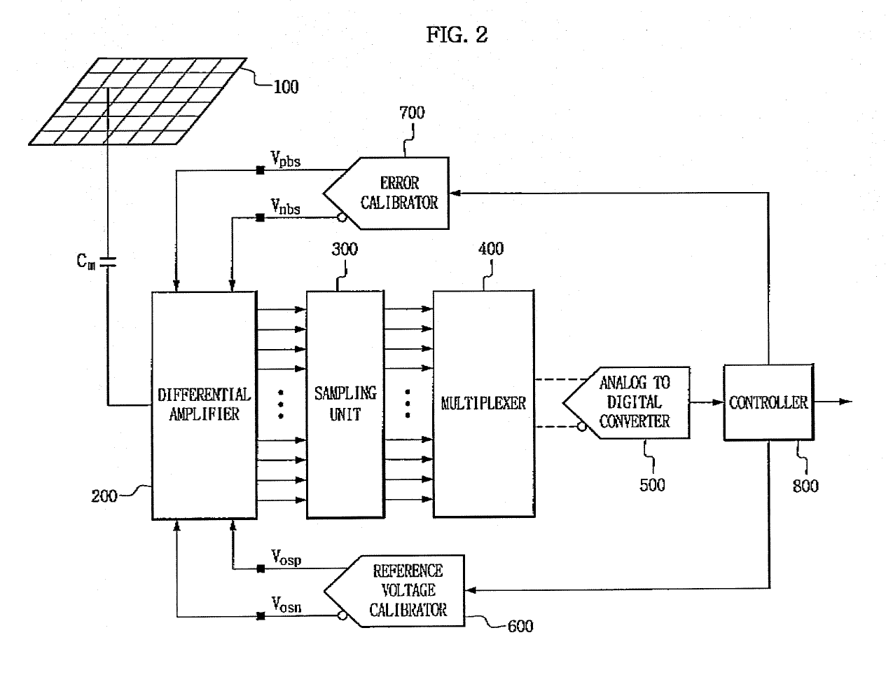

FIG. 2 illustrates the configuration of an apparatus for driving a touch panel according to an embodiment.

Referring to FIG. 2, the apparatus may include a touch panel 100, a differential amplifier 200, a sampling unit 300, a multiplexer 400, an analog to digital converter (ADC) 500, a reference voltage calibrator 600, an error calibrator 700 and a controller 800.

The touch panel 100 may include a plurality of Y-channels and a plurality of X-channels, and each pixel defined by the Y-channels and the X-channels is connected to a capacitor Cₘ in which an electric charge is stored. That is, the touch panel 100 is touched by a human body such as a finger, a change in the capacitance of the capacitor Cₘ in a pixel corresponding to a surface of the touch panel 100 touched by the human body occurs. The touch is recognized by sensing such a change in capacitance, and thus, the position of the region touched by the human body is recognized.

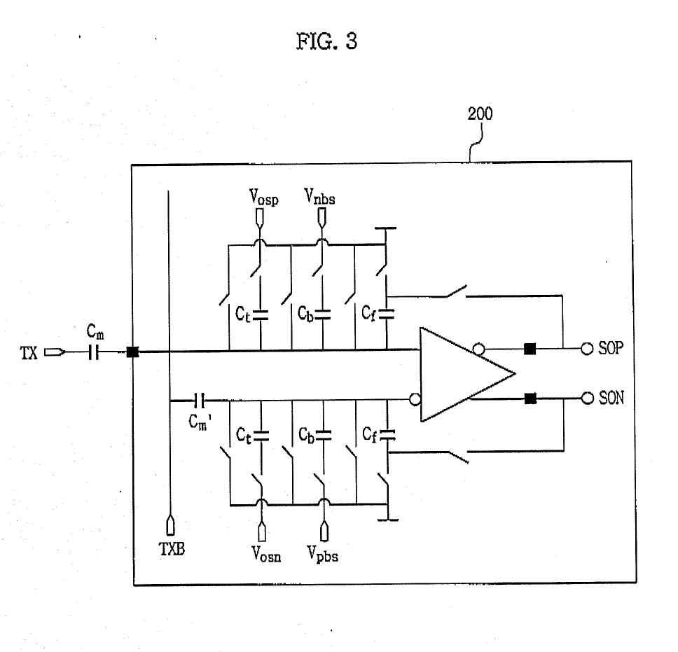

The differential amplifier 200 receives a change in charge amount based on the change in the capacitance of the capacitor Cₘ of the touch panel 100 inputted to a positive (+) input terminal, and drives a reverse pulse through a capacitor Cₘ′ connected to a negative (−) input terminal and amplifies the reverse pulse. Then, the differential amplifier 200 outputs an amplified voltage to two output terminals, i.e., positive (F) and negative (−) output terminals. The circuit structure of the differential amplifier 200 will be described in detail with reference to FIG. 3. Moreover, two pulse voltages of which phases are reverse with each other are used, so that the same signal can be amplified with a lower voltage than that of the related art.

The sampling unit 300 stores an output voltage for each channel of the differential amplifier 200, and outputs the two output voltages to the ADC 500 through the multiplexer 400.

The ADC 500 receives an output inputted from the differential amplifier 200 and converts the output into a digital value. Then, the ADC 500 outputs the converted digital value to the controller 800.

The reference voltage calibrator 600 may calibrate a reference voltage by outputting positive (+) and negative (−) voltages to the differential amplifier 200. At this time, the reference voltage calibrator 600 may be configured as an ADC. In this case, a predetermined reference voltage may be provided to the reference voltage calibrator 600. The reference voltage is a voltage that may be referred to as a start point or reference point in the whole calibration. Considering the characteristic that a voltage is decreased when a touch occurs, the reference voltage may be provided with a voltage greater than the half of the input range so as to avoid the case where when the touch occurs, the voltage is much decreased to be smaller than 0V, and therefore is below the input range of the ADC. The reference voltage also allows the output of the differential amplifier 200 not to be saturated by a supply voltage.

The error calibrator 700 may output positive (+) and negative (−) voltages to the differential amplifier 200 and calibrate the two output of the differential amplifier 200 so that they become voltages within, the voltage input range of the DAC. In this case, the error calibrator 600 may be configured as an ADC.

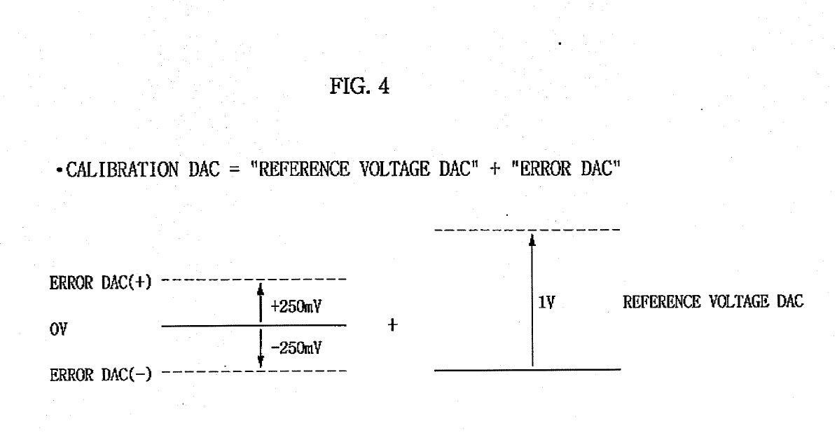

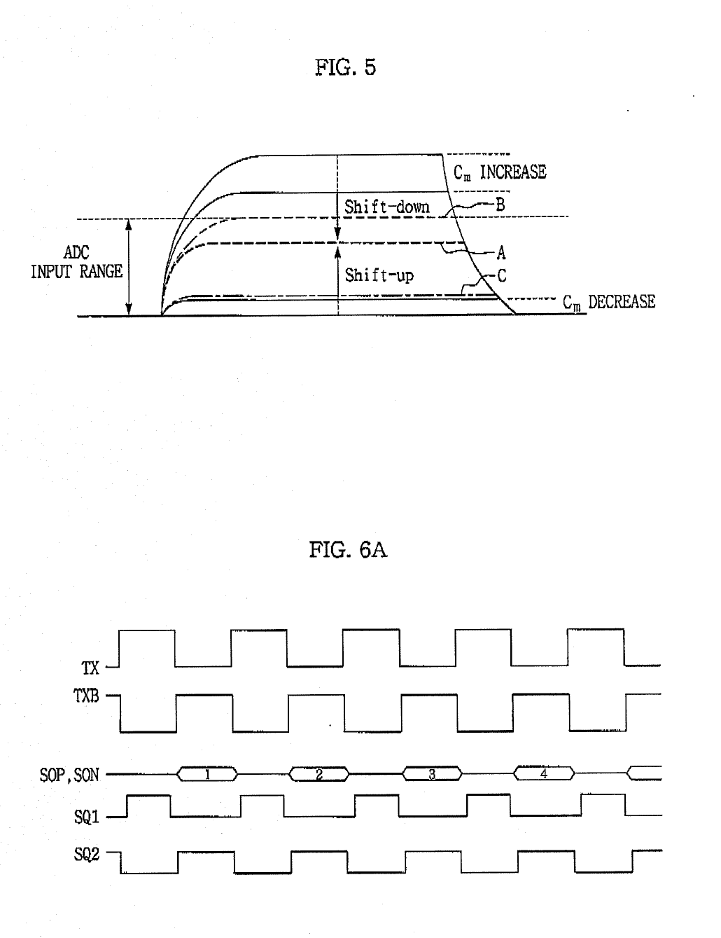

The calibration effect of the reference voltage calibrator 600 and the error calibrator 700, influenced on the output of the differential amplifier 200 will be described together with a circuit of FIG. 3 with reference to FIGS. 4 and 5.

The controller 800 receives two output values of the differential amplifier 200, which are beyond the voltage input range of the ADC 500, and determines whether or not it is necessary to calibrate the output values. Then, the controller 800 feeds back a correction value necessary for calibration to the error calibrator 700. That is, if the controller 800 feeds back the correction value as a digital value to the error calibrator 700 so as to inform that the output voltage of the differential amplifier 200 is beyond the voltage input range of the ADC 500, the error calibrator 700 coverts the digital value into an analog value and outputs positive and negative voltages to the differential amplifier 200, thereby correcting the output voltage of the differential amplifier 200. At this time, the controller 800 may perform feedback for error calibration every frame.

More specifically, outputs of the ADC 500 are all ‘high’ or ‘low’, they are previously beyond the input range of the ADC 500, and therefore, the ACD does not determines the exact voltage of each of the outputs. Thus, the controller 800 may feed back only the difference of the maximum or minimum value of the input range of the ADC from the reference value as a digital code to the error calibrator 700. Nevertheless, if outputs of the ADC 500 are all still ‘high’ or ‘low’, the aforementioned operation is repeatedly performed. That is, the operation is repeatedly performed until outputs of the ADC 500 are not all ‘high (overflow)’ or ‘low (underflow)’.

The controller 800 receives the output voltage that is amplified by the differential amplifier 200 and calibrated by the reference voltage calibrator 600 and the error calibrator 700 so as to detect whether or not an external touch occurs and to detect the position at which the external touch occurs.

FIG. 3 illustrates the structure of the differential amplifier according to the embodiment.

Referring to FIG. 3, in the differential amplifier 200, the amount of electric charges generated by a change in the capacitance of the capacitor Cₘ connected to each of the pixels of the touch panel is inputted to one input terminal of the differential amplifier 200, and a reverse pulse of TX is driven through another capacitor Cₘ′ connected to the differential amplifier 200, so that the difference between the amounts of electric charges inputted to the two input terminals is amplified.

The output voltage of the differential amplifier 200 according to the embodiment, which has two inputs and two outputs connected through the Cm and Cm′ respectively driven by TX and TXB, may be represented by the following Equation 2. The TX refers to a pulse for driving the touch panel, and the TXB refers to a pulse having the opposite phase of the TX. These pulses have the amplitude of Vₚᵤₗ.

$$S O P - S O N = \frac{{C}_{m}}{{C}_{f}} ( 2 {V}_{pul} ) \qquad ( 2 )$$

At this time, Equation 2 means an amplified output voltage to which the calibration effect of the reference voltage calibrator 600 and the error calibrator 700 is not applied.

By adding the TXB having the opposite phase of the TX, the differential amplifier 200 has the effect like that the TX is driven with a higher voltage than that of the related art, so that the differential amplification 200 can have a higher gain. Moreover, the differential amplifier 200 can have the same gain with a lower voltage so as to have the same effect as the related art.

Capacitors Cₜ are respectively provided on circuit paths along which the positive and negative voltages of the reference voltage calibrator 600 are inputted to the differential amplifier 200.

That is, Vₒₛₚ and Vₒₛₙ that are respectively positive and negative voltages outputted from the reference voltage calibrator 600 are stored in the Cₜ to be applied to the differential amplifier 200. The two outputs of the differential amplifier 200 are calibrated with a value obtained by multiplying the difference between the positive and negative voltages of the reference voltage calibrator 600 by Cₜ/C_{f} that is a capacitance ratio of capacitors connected to the reference voltage calibrator 600.

Capacitors C_{b} are respectively provided on circuit paths along which the positive and negative voltages of the error calibrator 700 are inputted to the differential amplifier 200.

That is, V_{pbs} and V_{nbs} that are respectively positive and negative voltages outputted from the error calibrator 700 are stored in the C_{b} to be applied to the differential amplifier 200. The two outputs of the differential amplifier 200 are calibrated using a value obtained by multiplying the difference between the positive and negative voltages of the error calibrator 700 by Cₜ/C_{f} that is a capacitance ratio of capacitors connected to the error calibrator 700.

The calibrated output voltage of the differential amplifier 200 may be represented by Equation 3 as follows.

$$S O P - S O N = \frac{{C}_{m}}{{C}_{f}} ( 2 {V}_{pul} ) - \frac{{C}_{t}}{{C}_{f}} ( {V}_{osp} - {V}_{osn} ) + \frac{{C}_{b}}{{C}_{f}} ( {V}_{pbs} - {V}_{nbs} ) \qquad ( 3 )$$

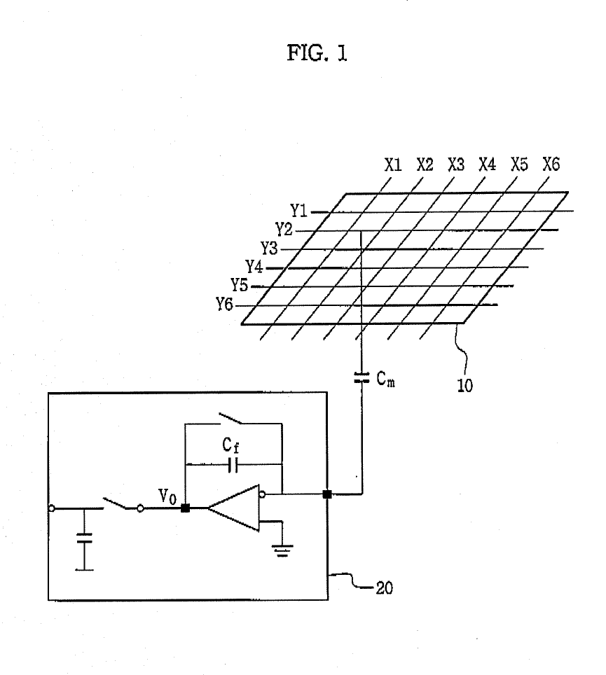

Here, Vₚᵤₗ denotes a pulse voltage inputted to each of the pixels on each of the Y-channels in FIG. 1. V_{pbs} and V_{nbs} denote positive and negative voltages outputted from the error calibrator 700, respectively, and Vosp and Vosn denote positive and negative voltages outputted from the reference voltage calibrator 600, respectively.

The output voltage of the differential amplifier 200 in the apparatus for driving the touch panel according to the embodiment the difference between the two outputs (SOP−SON) of the differential amplifier 200 will be described.

First, when no touch is generated, Vₚᵤₗ is set as 1.8V, and Vₒₛₚ−Vₒₛₙ is set as 1V. The Cₘ and C_{f} are set as C, and C₁ is set as 2C.

Thus, if the output voltage (SOP−SON) is applied to Equation 3, it becomes 2Vₚᵤₗ−2(Vₒₛₚ−Vₒₛₙ)+2(V_{pbs}−V_{nbs}). At this lime, the output of the ADC 500 may be 819 Code @10Bit. That is, 2Vₚᵤₗ−2(Vₒₛₚ−Vₒₛₙ)+2(V_{pbs}−V_{nbs})=2*1.8−2*1+4.8*0=18 (it is assumed that the output of the error calibrator 700 is 0V). When the input range of ADC 500 is 0 to 2V, 1code=2V/1024=1.953 mV, and hence, 1.6V/1.953 mV=819.2Code, i.e., approximately 819Code.

In this case, the output voltage is within the input range of the ADC 500, and therefore, an offset is unnecessary.

When a touch is generated, Vₚᵤₗ is set as 1.8V, and Vₒₛₚ−Vₒₛₙ is set as 1V. The Cₘ and C_{f} are decreased to 1C and 0.75C, respectively, and C₁ is set as 2C.

Thus, output voltage (SOP−SON) becomes 1.5Vₚᵤₗ−2(Vₒₛₚ−Vₒₛₙ)+2(V_{pbs}−V_{nbs}). At this time, the output of the ADC 500 may be 358 Code @10Bit. In this case, the output voltage is within the input range of the ADC 500, and therefore, an offset is unnecessary. Similarly, 1.5Vₚᵤₗ−2(Vₒₛₚ−Vₒₛₙ)+2 (V_{pbs}−V_{nbs})=1.5*1.8−2*1+2*0=700 mV. Since 70 mV/1.953 mV=358Code outputs of the ADC 500 are not all ‘lows’. Therefore, error calibration is unnecessary.

Hereinafter, a case where a change is generated in the touch panel due to an external environment will be considered.

The case where the Cₘ of the touch panel is increased in the state that no touch is generated will be described.

In this case, Vₚᵤₗ is set as 1.8V, and C_{f} is set as 1C. The Cₘ is set as 1.5C, and Cₜ, is set as 2C. Thus, if the output voltage (SOP−SON) is applied to Equation 3, it becomes 3Vₚᵤₗ−2(Vₒₛₚ−Vₒₛₙ)+1(V_{pbs}−V_{nbs}). Accordingly, the ADC 500 has an overflow value that is beyond the maximum input range thereof. In this case, the output is calibrated with a negative (−) offset, so that the output voltage can be calibrated within the input range of the ADC 500. More specifically, 3Vₚᵤₗ−2(Vₒₛₚ−Vₒₛₙ)+1(V_{pbs}−V_{nbs})=3*1.8−2*1+2*0=3 4V, which is over 2V, and therefore, it is determined that the ADC 500 has an overflow value. In this case, the difference between the reference voltage and 2V is calculated, and an error is corrected based on the difference.

The case where a touch is generated in the state that the Cₘ is increased will be described.

In this case, Vₚᵤₗ is set as 1.8V, and C_{f} is set as 1C. The Cₘ is set as 1.25C, and Cₜ is set as 2C. Thus, if the output voltage (SOP−SON) is applied to Equation 3, it becomes 2.5Vₚᵤₗ−2(Vₒₛₚ−Vₒₛₙ)+2(V_{pbs}−V_{nbs}). Accordingly, the ADC 500 has an overflow value that is beyond the maximum input range thereof. In this case, the output is calibrated with a negative (−) offset, so that the output voltage can be calibrated within the input range of the ADC 500.

The case where no touch is generated in the state that the Cₘ is decreased will be described.

In this case, Vₚᵤₗ is set as 1.8V, and C_{f} is set as 1C. The Cₘ is set as 0.5C, and Cₜ is set as 2C. Thus, if the output voltage (SOP−SON) is applied to Equation 3, it becomes Vₚᵤₗ−2(Vₒₛₚ−Vₒₛₙ)+2(V_{pbs}−V_{nbs}). Accordingly, the ADC 500 has an underflow value that is beyond the minimum input range thereof. In this case, the output is calibrated with a positive (+) offset, so that the output voltage can be calibrated within the input range of the ADC 500. More specifically, Vₚᵤₗ−2(Vₒₛₚ−Vₒₛₙ)+2(V_{pbs}−V_{nbs})=1.8−2*1+2*0=0.2V, which is smaller by 200 mV than the input range of the ADC 500, and therefore, error calibration is necessary. That is, a positive (+) offset is necessary.

The case where a touch is generated in the state that the Cₘ is decreased will be described.

In this case, Vₚᵤₗ is set as 1.8V, and C_{f} is set as 1C. The Cₘ is set as 0.25C, and Cₜ is set as 2C. Thus, if the output voltage (SOP−SON) is applied to Equation 3, it becomes 0.5Vₚᵤₗ−2(Vₒₛₚ−Vₒₛₙ)+2(V_{pbs}−V_{nbs}). Accordingly, the ADC 500 has an underflow value that is beyond the minimum input range thereof. In this case, the output is calibrated with a positive (+) offset, so that the output voltage can be calibrated within the input range of the ADC 500.

FIGS. 4 and 5 illustrate the calibration effect by a reference voltage calibrator and an error calibrator according to the embodiment. In FIG. 5, if the Cₘ is increased, the output value is calibrated with a negative offset, and if the Cₘ is decreased, the output voltage is calibrated with a positive offset.

Referring to FIG. 5, if line A becomes a reference voltage and the output voltage is beyond line B, i.e., it has a value (overflow) that is beyond the maximum input range of the ADC 500, it is shifted down within the line B through error calibration. If, the output voltage is below line C, i.e., it has a value (underflow) that is beyond the minimum input range of the ADC 500, it is shifted up above the line C through error calibration. At this time, like the line B or C, the voltage that becomes a reference of the overflow or underflow may be set to be slightly smaller or greater than the real input range of the ADC. This is because it is considered that the output code of the ADC is slightly shaken on the time axis due to the offset of the ADC and several factors.

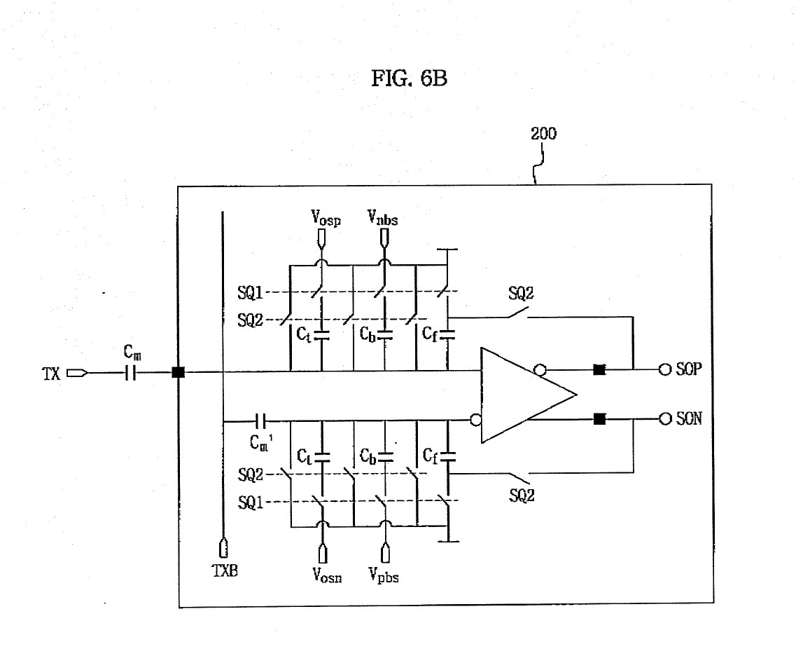

FIG. 6A illustrates a timing diagram of signals for controlling an apparatus for driving a touch panel according to the embodiment, and FIG. 6B illustrates components of the differential amplifier controlled by the signals illustrated in the timing diagram of FIG. 6A.

As described above, the apparatus for driving the touch panel according to the embodiment has advantages as follows.

The gain of the differential amplifier is enhanced even when the amount of electric charges stored in the capacitor of each of the pixels due to an external touch input is small, so that the touch sensitivity can be increased.

When a drift of the output voltage is generated due to a change of the external environment or touch panel, the output voltage is calibrated within the input range of the ADC, thereby preventing saturation of the output voltage.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An apparatus for driving a touch panel, the apparatus comprising:
a touch panel having a plurality of pixels, wherein each of the pixels is connected to a first capacitor in which their electric charges are stored;
a differential amplifier for receiving and amplifying the amount of electric charges generated by a change in the capacitance of the first capacitor of the touch panel, inputted through two input terminals and outputting the amplified voltage to two output terminals;
an analog to digital converter (ADC) for receiving an output of the differential amplifier as an input and converting the output into a digital value;
a reference voltage calibrator for outputting positive and negative voltages to the differential amplifier and calibrating a reference voltage;
an error calibrator for outputting positive and negative voltages to the differential amplifier and calibrating two outputs of the differential amplifier within a voltage input range of the ADC; and
a controller for feeding back the two outputs of the differential amplifier, which are beyond the voltage input range of the ADC, to the error calibrator.

2. The apparatus according to claim 1, wherein capacitors are respectively provided on circuit paths along which the voltage generated by the change in the capacitance of the first capacitor is inputted to the two input terminals of the differential amplifier.

3. The apparatus according to claim 1, wherein capacitors are respectively provided on circuit paths along which the positive and negative voltages of the reference voltage calibrator are inputted to the differential amplifier.

4. The apparatus according to claim 3, wherein the two outputs are calibrated using a value obtained by multiplying the difference between the positive and negative voltages of the reference voltage calibrator by a capacitance ratio of capacitors connected to the reference voltage calibrator.

5. The apparatus according to claim 1, wherein capacitors are respectively provided on circuit paths along which the positive and negative voltages of the error calibrator are inputted to the differential amplifier.

6. The apparatus according to claim 5, wherein the two outputs are calibrated using a value obtained by multiplying the difference between the positive and negative voltages of the error calibrator by a capacitance ratio of capacitors connected to the reference voltage calibrator.

7. The apparatus according to claim 1, wherein the controller controls the output of the differential amplifier every frame.
